(19) United States
(12) Patent Application Publication
(10) Pub. No.: US 2014/0230741 A1
(43) Pub. Date: Aug. 21, 2014

(54) WIRELESS POWER FOR INTERNAL ELEMENTS OF AQUARIUM

(71) Applicant: Elive LLC, New Berlin, WI (US)

(72) Inventors: Matthew Allen, Waterford, WI (US); Thomas Lutz, Cedar Rapids, IA (US)

(21) Appl. No.: 14/182,010

(22) Filed: Feb. 17, 2014

Related U.S. Application Data
(60) Provisional application No. 61/765,278, filed on Feb. 15, 2013.

(51) Int. Cl. A01K 63/00; A01K 63/06

(52) U.S. Cl. CPC A01K 63/006; A01K 63/06
USPC 119/267; 119/245

(57) ABSTRACT

An aquarium includes a wall separating an internal environment within the enclosure from an external environment outside of the enclosure, and a power transmission system that transmits power wireless through the wall. The power transmission system includes a power source and an external inductor coupled to the power source, the external inductor coupled to the wall. The power transmission system also includes an internal inductor coupled to the wall and separated from the external inductor by the wall, and an internal element disposed within the enclosure, the internal element coupled to the internal conductor.

### CROSS-REFERENCE TO RELATED APPLICATIONS

This application claims priority to U.S. Provisional Application No. 61/765,278, filed Feb. 15, 2013, the entire contents of which are incorporated herein by reference.

### BACKGROUND

The present invention relates to lighting and decor for aquariums. More particularly, the present invention relates to providing power to lighting and decor in an aquarium.

Residential aquarium keeping is a mature and established industry in the United States and around the world. A basic version of an aquarium includes a transparent container for aquatic life to be viewed and housed within. These containers are typically constructed of either glass or a transparent plastic material such as acrylic or polystyrene, but may be made of other transparent or semi-transparent materials. Basic aquatic environments of this nature are limited in their ability to sustain suitable conditions and water quality for all but a handful of robust and hearty fish. Often more appropriate for the health and well-being of the aquatic organisms is the addition of filtration, lighting, oxygenation, temperature control, chemical and biological balance.

### SUMMARY

In accordance with one construction, an aquarium includes a wall separating an internal environment within the enclosure from an external environment outside of the enclosure, and a power transmission system that transmits power wireless through the wall. The power transmission system includes a power source and an external inductor coupled to the power source, the external inductor coupled to the wall. The power transmission system also includes an internal inductor coupled to the wall and separated from the external inductor by the wall, and an internal element disposed within the enclosure, the internal element coupled to the internal conductor.

In accordance with another construction, an aquarium includes a base defining a base perimeter and a wall extending from the base perimeter and surrounding the base to define a substantially water tight interior space, at least a portion of the wall being substantially transparent to visible light. A power source is disposed outside of the interior space and operable to receive an AC power supply and to output an external power supply. An external inductor is coupled to the wall and receives the external power supply from the power source. An internal inductor is disposed in the interior space adjacent the external inductor. The internal inductor is operable to output an internal power in response to the receipt of the external power at the external inductor. An electrical element is electrically connected to the internal inductor and operable in response to receipt of a portion of the internal power.

### BRIEF DESCRIPTION OF THE DRAWINGS

FIG. 1 is a schematic illustration of a wireless power transmission system according to one construction for powering an internal element within an aquarium.

FIG. 2 is a perspective view of a wireless power transmission system according to another construction for powering a plurality of internal lighting elements within an aquarium, each of the internal lighting elements coupled to the same internal inductors.

FIG. 3 is a perspective view of a wireless power transmission system according to another construction for powering a plurality of internal lighting elements within an aquarium, each of the internal lighting elements coupled via a wire to separate internal inductors.

FIG. 4 is a perspective view of a wireless power transmission system according to another construction for powering an internal element or elements within an aquarium, each of the internal lighting elements coupled wirelessly to separate internal inductors.

### DETAILED DESCRIPTION

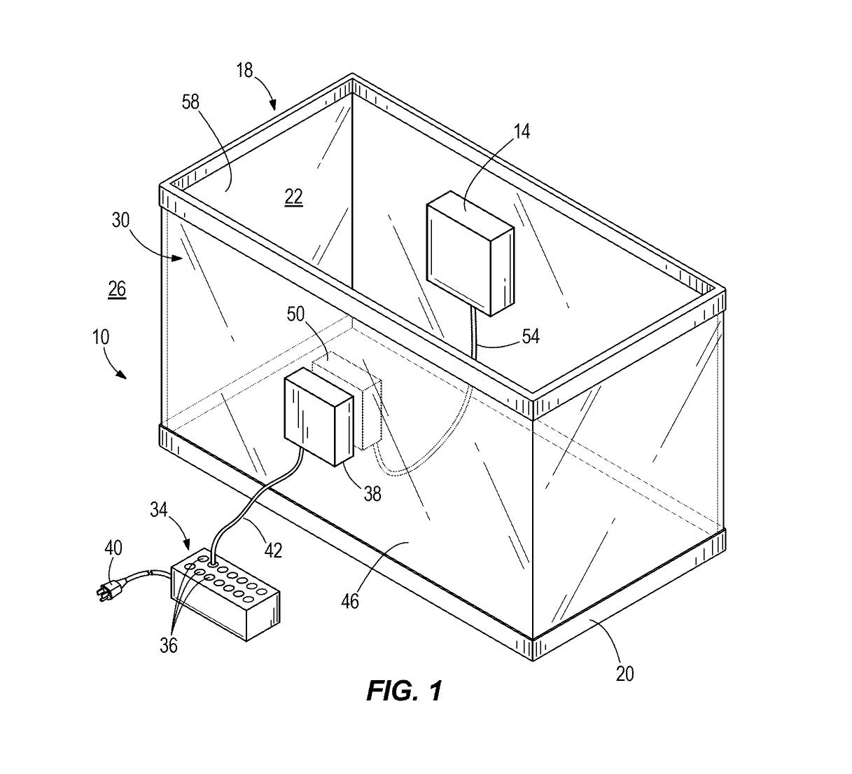

FIG. 1 schematically illustrates a wireless power transmission system 10 for powering an internal element 14 within an aquarium 18 or other container. The internal element 14 is a light, a motor, a pump, or any other device within the aquarium 18 that can be run electrically through a wireless connection.

The aquarium 18 includes a base 20 and a removable top (not shown). The illustrated aquarium 18 is constructed of glass, acrylic, clear plastic, or other material that separates and defines an internal environment 22 and an external environment 26. The aquarium 18 includes a glass wall 30 that extends from the base 20 and is clear and transparent, although in some constructions the wall 30 or a portion of the wall 30 is opaque. The internal environment 22 is substantially water tight enabling it to contain an aquatic environment. In some constructions the internal environment 22 is dry or semi-arid in order to contain other animals such as snakes, lizards, birds, hamsters, guinea pigs, spiders, crickets, frogs, toads, etc.

With continued reference to FIG. 1, the system 10 includes a power source 34 having one or more plug-in locations 36 disposed thereon, an external inductor 38, and at least one wire 42 that extends from one of the plug-in locations 36 and couples the power source 34 to the external inductor 38 to provide power from the power source 34 to the external inductor 38. A power cord 40 supplies power to the power source 34 (e.g., from a common AC electrical outlet). In some constructions the system 10 includes one or more rectifiers/inverters in the power source 34 (or elsewhere) to convert current as needed to power the internal elements 14.

As illustrated in FIG. 1, the external inductor 38 is coupled to an outer surface 46 of the wall 30. In some constructions the power source 34 is coupled directly to the external inductor 38 without the use of an exposed wire 42. In addition, some constructions include a power source having one or more wires permanently attached and extending from the power source to one or more inductors.

The system 10 further includes an internal inductor 50 and a wire 54 that couples the internal inductor 50 to the internal element 14 within the aquarium 18 to provide power from the internal inductor 50 to the internal element 14. In some constructions the internal inductor 50 is coupled directly to the internal element 14 without the use of the exposed wire 54. As illustrated in FIG. 1, the internal inductor 50 is coupled to an inner surface 58 of the wall 30, directly opposite the external inductor 38.

The wall 30 provides a separation barrier between the internal and external environments 22, 26 through which power is transferred wirelessly and inductively from the external inductor 38 to the internal inductor 50. Electromagnetic principles enable power transmission through the wall 30, which is typically an electrical insulator or electrically non-conductive material.

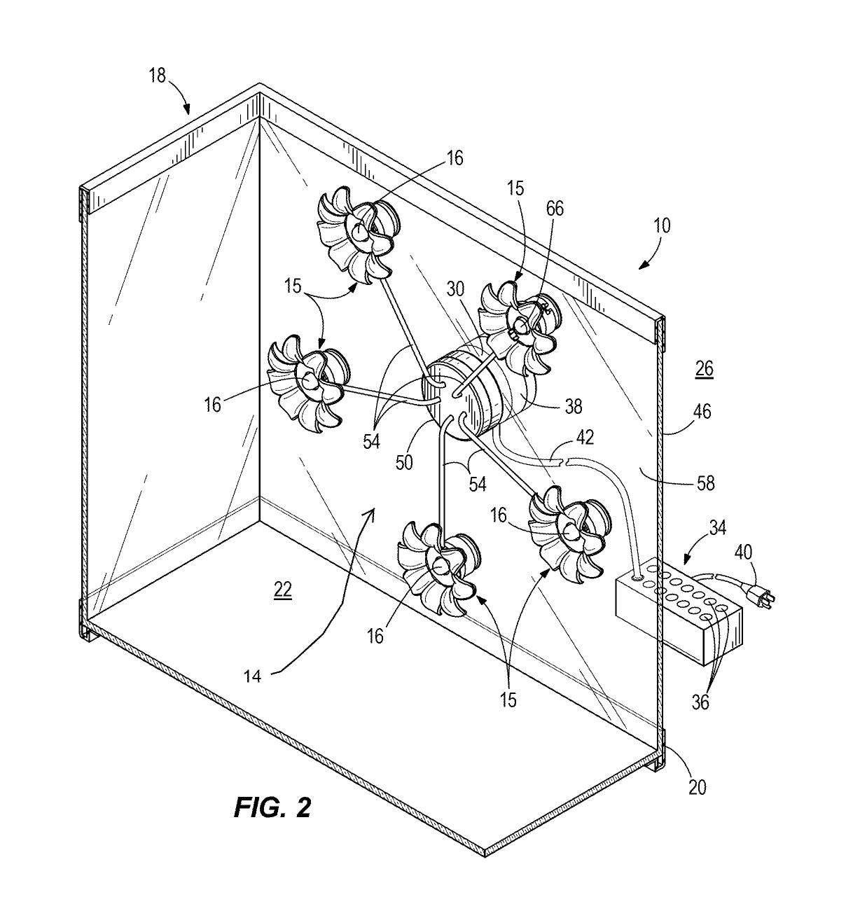

FIGS. 2-4 illustrate constructions that include a variety of internal elements 14 in the form of lights 15. In the illustrated constructions each of the lights 15 includes a light-emitting diode (LED) 62 that operates in response to the flow of internal power to emit light. Of course, other constructions might use other light sources in place of or in conjunction with the LEDs 62.

In one construction illustrated in FIG. 2, each of the lights 15 includes an exposed wire 54 between the light 15 and the internal inductor 50, and a single exposed wire 42 is disposed between the internal conductor 50 and the power source 34. Thus, the arrangement of FIG. 2 delivers all of the power necessary for the lights 15 from the power source 34 to one external inductor 38. The single external inductor 38 wirelessly delivers that power to the single internal inductor 50 which then distributes that power evenly to all of the lights. In this arrangement, any controls (e.g., dimmers) applied to the external power path would have a substantially equal effect on all of the lights 15.

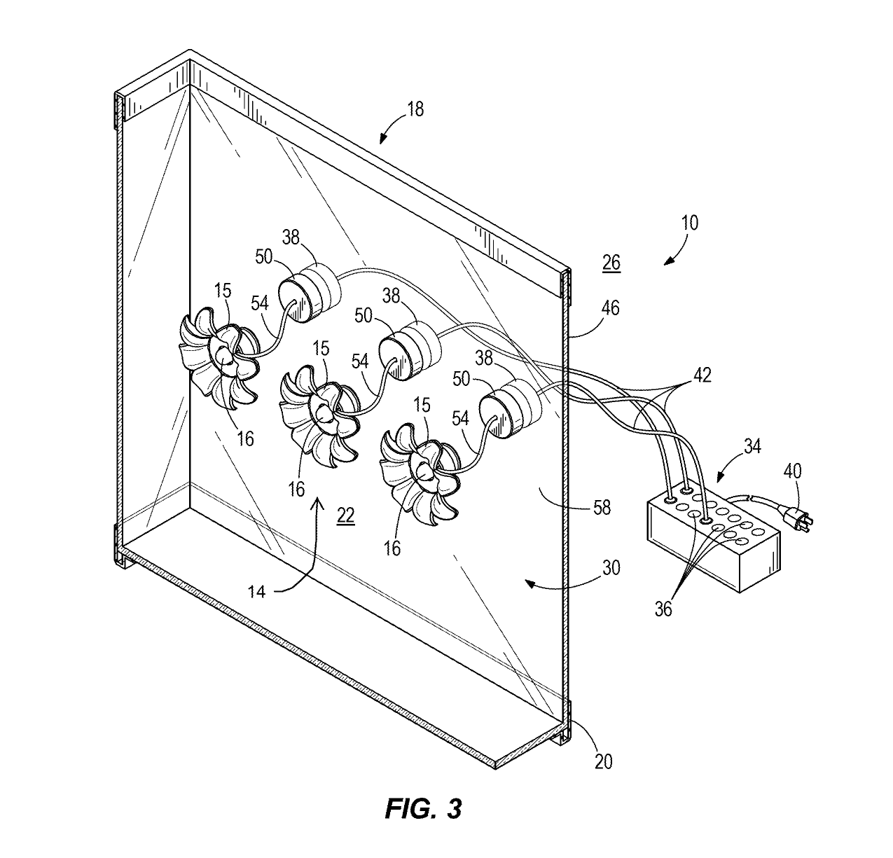

FIG. 3 illustrates an alternative arrangement in which the internal element 15 includes three separate lights 14. Each of the lights 14 is similar to the lights 14 of FIG. 2. However, each of the lights of FIG. 3 receives power from a separate internal inductor 50. While the internal inductors 50 are substantially the same as the internal inductor of FIG. 2, there are more of them. Each internal inductor 50 is positioned adjacent separate external inductors 38. As with the internal inductors 50, the external inductors 38 are similar to the external inductors 38 of FIG. 2 but there are more of them. Each external inductor 38 received power via a separate wire 42 that is connected to a separate plug-in location on the power source 34. Thus, the arrangement of FIG. 3 provides three separate flow paths for power from the power source 34 to the lights 15, thereby allowing for variation in the power delivered to individual lights 15 if desired. In a variation of the construction of FIG. 3, the three wires 42 could all connect to the power source 34 at a single plug-in location if desired.

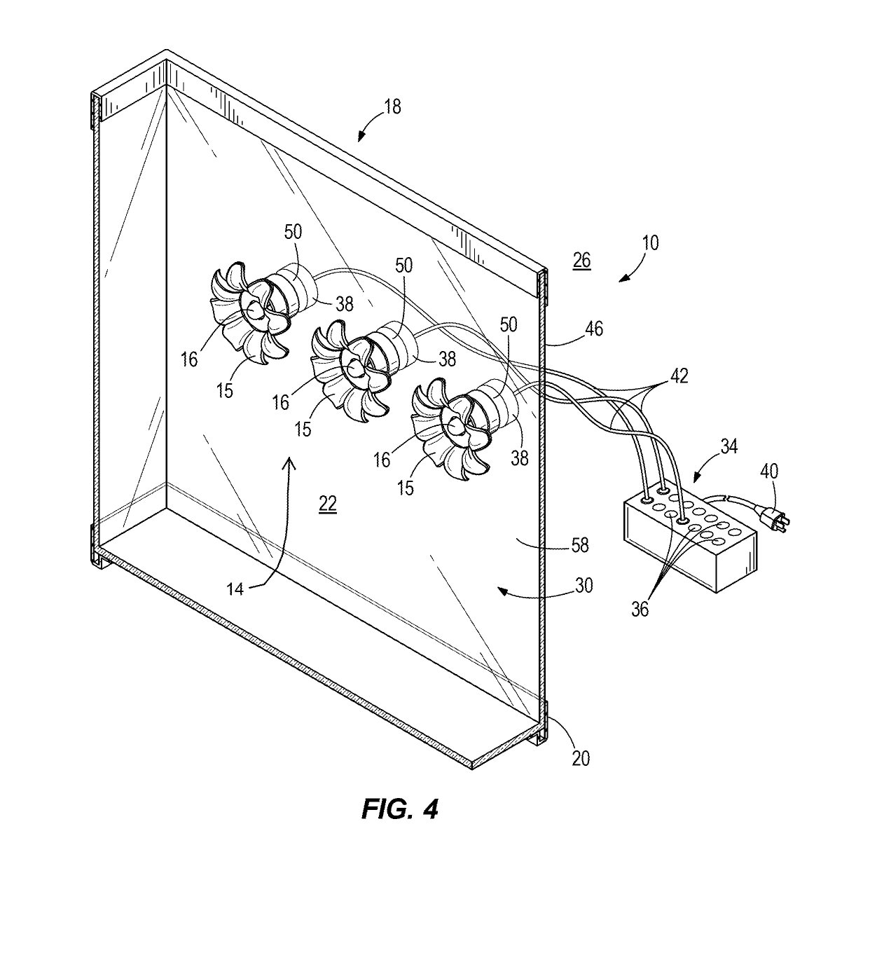

FIG. 4 illustrates another construction that is similar to the construction of FIG. 3. However, rather than providing a wire between the interior inductors 50 and the lights 15, the lights 15 are directly connected to or formed as part of the internal inductors 50

The power transmission system 10 eliminates the need for the power cord 40 to extend over a top edge of the aquarium 18 and into the aquarium 18, thus alleviating problems (e.g., impingements from aquarium covers, filters, and other structures, water dripping down the power cord, pinching of the power cord, crimping of the power cord, animals chewing, clawing, or burrowing into the power cord, etc.) that exist in current power transmission applications, as well as providing a more aesthetically pleasing appearance.

As discussed herein, the internal inductor 38 and the external inductor 50 are disposed on opposite sides of the wall 22 and are preferably connected to the wall 22. Many options are available for connecting the internal inductor 38 and the external inductor 50 to the wall including but not limited to, double-sided tape, adhesives, magnets, suction cups, brackets or fixtures, and the like.

Various features and advantages of the invention are set forth in the following claims.

1. An aquarium comprising:
a wall separating an internal environment within the enclosure from an external environment outside of the enclosure;
a power transmission system that transmits power wireless through the wall, the power transmission system including:
a power source;
an external inductor coupled to the power source, the external inductor coupled to the wall;
an internal inductor coupled to the wall and separated from the external inductor by the wall; and
an internal element disposed within the enclosure, the internal element coupled to the internal conductor.

2. The aquarium of claim 1, wherein the external inductor is coupled to the power source with a wire.

3. The aquarium of claim 1, wherein the internal inductor is coupled to the internal element with a wire.

4. The aquarium of claim 1, wherein the internal element includes components selected from a group consisting of a light, a motor, and a pump.

5. The aquarium of claim 1, wherein the power transmission system includes a single external inductor, a single internal inductor, and a plurality of internal elements coupled to the single internal inductor.

6. The aquarium of claim 5, wherein each of the plurality of internal elements is coupled to the single internal inductor with a wire.

7. The aquarium of claim 5, wherein each of the plurality of internal elements is a lighting element having an LED.

8. The aquarium of claim 1, wherein the power transmission system includes a plurality of external inductors, a plurality of internal inductors, and a plurality of internal elements, each of the internal elements coupled to one of the internal inductors.

9. The aquarium of claim 8, wherein each of the plurality of internal elements is coupled to one of the internal inductors with a wire.

10. The aquarium of claim 8, wherein each of the plurality of internal elements is coupled to one of the internal inductors directly, without a wire.

11. The aquarium of claim 8, wherein each of the plurality of internal elements is a lighting element having an LED.

12. The aquarium of claim 8, wherein each of the plurality of external inductors is coupled to the power source with a wire.

13. An aquarium comprising:
a base defining a base perimeter;
a wall extending from the base perimeter and surrounding the base to define a substantially water tight interior space, at least a portion of the wall being substantially transparent to visible light;
a power source disposed outside of the interior space and operable to receive an AC power supply and to output an external power supply;
an external inductor coupled to the wall and receiving the external power supply from the power source;
an internal inductor disposed in the interior space adjacent the external inductor, the internal inductor operable to output an internal power in response to the receipt of the external power at the external inductor; and
an electrical element electrically connected to the internal inductor and operable in response to receipt of a portion of the internal power.

14. The aquarium of claim 13, wherein the base perimeter is rectangular and the wall includes four substantially planar members, and wherein the interior space is cubic.

15. The aquarium of claim 13, wherein the AC power supply alternates at less than about 60 Hz, and wherein the external power supply alternates at a frequency of at least about 100 Hz.

16. The aquarium of claim 13, wherein the electrical element is one of a plurality of electrical elements and wherein each electrical element is electrically connected to the internal inductor and operable in response to receipt of a portion of the internal power.

17. The aquarium of claim 13, wherein the electrical element is one of a plurality of electrical elements and the internal inductor is one of a plurality of internal inductors, and wherein each of the electrical elements is electrically connected to only one of the internal inductors.

18. The aquarium of claim 17, wherein the external inductor is one of a plurality of external inductors and wherein each of the external inductors is connected to the wall and wherein each of the internal inductors is disposed adjacent only one of the external inductors.

19. The aquarium of claim 18, wherein the power source includes a plurality of power outputs, and wherein each of the power outputs is connected to only one of the external inductors and each of the external inductors is connected to only one of the power outputs.

20. The aquarium of claim 13, wherein the electrical element is one of the group consisting of a light, a water pump, and an air compressor.
